(19) United States
(12) Patent Application Publication
(10) Pub. No.: US 2016/0104477 A1
(43) Pub. Date: Apr. 14, 2016

(54) METHOD FOR THE INTERPRETATION OF AUTOMATIC SPEECH RECOGNITION

(71) Applicant: Deutsche Telekom AG, Bonn (DE)

(72) Inventor: Felix Burkhardt, Berlin (DE)

(21) Appl. No.: 14/880,290

(22) Filed: Oct. 12, 2015

(30) Foreign Application Priority Data
Oct. 14, 2014 (DE) 10 2014 114 845.2

(51) Int. Cl. G10L 15/06; G10L 13/02

(52) U.S. Cl. CPC G10L 15/06; G10L 13/02; G10L 2015/0633

(57) ABSTRACT

A device for automated improvement of digital speech interpretation on a computer system includes: a speech recognizer, configured to recognize digitally input speech; a speech interpreter, configured to accept the output of the speech recognizer as an input, and to manage a digital vocabulary with keywords and their synonyms in a database in order to trigger a specific function; and a speech synthesizer, configured to automatically synthesize the keywords and to feed them to the speech recognizer in order to then insert its output as further synonyms into the database of the speech interpreter if they differ from the keywords or their synonyms.

### CROSS-REFERENCE TO RELATED APPLICATIONS

Priority is claimed to German Patent Application No. DE 10 2014 114 845.2, filed on Oct. 14, 2014, the entire disclosure of which is hereby incorporated by reference herein.

### FIELD

The invention relates to a method and device for improving the interpretation of speech recognition results by the automated finding of words which were misunderstood by the speech recognition component.

### BACKGROUND

Two major sub-steps are applied for speech interpretation in the state-of-the-art systems:

A speech recognition system comprises the following component parts: preprocessing which breaks down the analog speech signals into the individual frequencies.

The actual recognition takes place subsequently with the help of acoustic models, dictionaries and speech models.

Preprocessing consists essentially of the steps: sampling, filtering, transformation of the signal into the frequency band and creation of the feature vector.

A feature vector is created for the actual speech recognition. This consists of features which are dependent on or independent of each other that are generated from the digital speech signal. In addition to the spectrum already mentioned, it also includes above all the cepstrum. Feature vectors may be compared, for example, by means of previously defined metrics.

In the model of the recognition process there are different approaches such as hidden Markov models, neuronal networks or combinations and derivations thereof.

The speech model subsequently attempts to determine the probability of certain word combinations and, as a result, to exclude incorrect or improbable hypotheses. To do this it is possible to use either a grammar model employing formal grammars or a statistical model with the help of n-grams.

If grammars are used, they are generally context-free grammars. However, in this case the function of every word must be assigned to it within the grammar For this reason, such systems are generally only used for a limited vocabulary and special applications, but not in the popular speech recognition software for PCs.

There are already predefined vocabularies for the integration of speech recognition systems which are intended to make working with speech recognition easier. The better the vocabulary is matched to the vocabulary and dictation style used by the speaker (frequency of word sequences), the higher the recognition accuracy. In addition to the speaker-independent lexicon (specialist and basic vocabulary), a vocabulary also includes an individual word sequence model (speech model). All words known to the software are stored in the vocabulary in their phonetic and orthographic form. In this way, the system recognizes a spoken word by its sound. If words differ in meaning and spelling but sound the same, the software falls back on the word sequence model. It defines the probability with which one word will follow another for a specific user.

The following prior art is additionally known:
Speech recognition method DE102010040553A1
Real-time automated interpretation of clinical narratives AU002012235939A1
Speech recognition in two passes with restriction of the active vocabulary DE000060016722T2

At the same time, a very large number of patents deal with the finding of synonyms, here is a small selection:
A method and system for adapting synonym resources to specific domains AU000200193596A
English synonym and antonym inquiring and recognizing device CN000202887493U
Synonym expansion method and device both used for text duplication detection CNOOO 1 02650986A
Database search using synonym groups EP000002506161A1
SYNONYM CONVERSION SYSTEM, SYNONYM CONVERSION METHOD AND SYNONYM CONVERTING PROGRAM JP002009230173A

[1]Mining the Web for synonyms: PMI-IR versus LSA on TOEFL, P. Tumey, 2001, Proceedings of the Twelfth European Conference on Machine Learning (ECML-2001)

In addition, there are basically two types of speech recognition with interpretation:

In the first and historically older case, only certain inputs, which are defined in a so-called “grammar”, can be recognized.

In the second case, statistical recognition, the possible inputs are not specified in advance but, due to collections of very large written speech corpora, in principle every possible utterance within a language can be recognized. This has the advantage that the designer of the application need not consider in advance which utterances the user will make. The disadvantage is that the text still has to be interpreted in a second step (if the speech input is intended to lead to actions in the application), whereas in grammar-based recognition the interpretation can be specified directly in the grammar. The invention described here relates to the second method, unlimited recognition, as only here is it necessary to establish a match between the recognition result and the interpretation.

### PRIOR ART

### Speech Synthesis

Speech synthesizers generate an acoustic speech signal from an input text and set of parameters for speech description

Traditionally, the following different approaches exist:
Parametric synthesizers generate the signal from speech models while being flexible in respect of general speaker modelling although the signal quality is often of lower quality. Parametric synthesizers work mainly according to the source-filter model. In this case, a signal generator sends an input signal to a linear filter. At the same time the filter models the transfer function of the vocal tract. In parametric synthesis, a distinction is drawn between formant synthesis and synthesis according to linear prediction. Options and limitations of parametric synthesis but also of parametric signal transmission will be referred to here. At the same time, the historical development is highlighted based on some examples of parametric synthesizers. This also includes articulatory speech synthesis which is applied less in practice than for basic research.
Concatenative synthesizers generate the speech signal by concatenating appropriate sections of speech from very large databases. The speech quality in this case is very good within the domains of the database, however the speaker modelled is precisely the one from whom the database originates. Different domains therefore have to be considered and provided. Such a system comprises in a possible embodiment of the following modules: symbol processing, concatenation, acoustic synthesis and prosody control which works in parallel and supplies the other modules with additional information. Symbol processing works on the level of textual and phonetic symbols. The concatenation module converts an annotated phonetic text, that is a discrete string of characters, into a continuous data stream of acoustic parameters. Particular attention has to be paid to sound transitions and co-articulation effects to be able to imitate human articulation adequately when speaking. The acoustic synthesizer generates the speech signal from the parameters. The overriding principle when assessing the synthetic signal is intelligibility and naturalness. The PSOLA method achieved great importance here as it enables the duration and melody of spoken language to be manipulated independently of the other acoustic properties. Systems which work according to the principle of unit selection were developed to further increase the naturalness of synthetically generated speech. Such systems are based on very large corpora/domains of natural linguistic utterances from which the optimal building blocks, with regard to the target utterance to be produced, are selected with the help of an algorithm.

The second method especially is preferably suitable for producing understandable and human-like speech signals from virtually any content. In this case, one system can simulate several speaking voices, in the case of parametric synthesis by altering speaker-specific parameters, in the case of concatenative synthesis by using speech material of different speakers. Within the meaning of the invention, it is helpful to confront the speech recognizer with different speaking voices in order to map as large a number as possible of the speaking voices of potential users.

Thus speech synthesis/speech synthesizing is understood as the synthetic generation of the human speaking voice. A text-to-speech system (TTS) (or automated read-aloud system) converts running text into an acoustic speech output. Thus the two approaches for generating speech signals referred to above can be differentiated. On the one hand, it is possible by means of so-called signal modelling to fall back on speech recordings (samples). On the other hand, however, the signal can also be generated entirely in the computer by means of so-called physiological (articulatory) modelling. While the first systems were based on formant syntheses, the systems currently used industrially are based predominantly on signal modelling.

In prior art in the present environment, the spoken audio signal is first converted by a speech recognizer into a quantity of words. In a second step, this quantity of words is transformed by an interpreter into a take-action instruction for further machine processing.

As an example, the utterance “what's on at the cinema today” leads to a database search in today's cinema programme.

Technically this happens in that the keyword chains “today” and “cinema” are linked to the date of the relevant day and the cinema programme by a control structure.

In this case, we speak within a specific application of the “knowledge domain” (“domain” for short), for cinema information, for example, this would be “films, actors and cinemas”, for a navigation system the “streets and place names”, etc.

As can be seen in FIG. 1, both the speech recognizer and also the interpreter need speech models, that is word lists or vocabularies which are obtained from specific domains, as the database for training their function.

A problem then occurs if both components have been trained by different domains or if errors were made during transcription of the word lists, both of which mean that matching (that is assignment) of the speech recognition result with the keywords no longer takes place.

Take the name of the singer “Herbert Gronemeyer” for example, the transcription of which results in “Herbert Gronemeier” (with “i” instead of “y”) for one of the most widely used speech recognizers throughout Germany (the Google service).

### SUMMARY

In an embodiment, the invention provides a device for automated improvement of digital speech interpretation on a computer system. The device includes: a speech recognizer, configured to recognize digitally input speech; a speech interpreter, configured to accept the output of the speech recognizer as an input, and to manage a digital vocabulary with keywords and their synonyms in a database in order to trigger a specific function; and a speech synthesizer, configured to automatically synthesize the keywords and to feed them to the speech recognizer in order to then insert its output as further synonyms into the database of the speech interpreter if they differ from the keywords or their synonyms.

### DESCRIPTION OF THE FIGURES

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a classic speech model; and

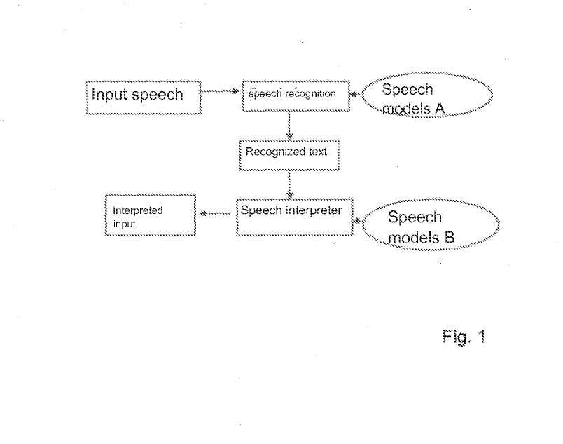

FIG. 2 shows the workflow of the present invention.

### DETAILED DESCRIPTION

In an embodiment, the invention overcomes the disadvantages referred to above.

In an embodiment, the invention includes automatically feeding the speech recognizer with the words to be recognized by means of a speech synthesizer and then making the results, because they then differ from the input, available to the interpreter as synonyms or utterance variations.

Exemplary embodiments of the invention include a method and a device. In particular, a device for automated improvement of digital speech interpretation on a computer system. This comprises a speech recognizer which recognizes digitally input speech. Furthermore, a speech interpreter is provided which accepts the output of the speech recognizer as an input, the speech interpreter manages a digital vocabulary with keywords and their synonyms in a database in order to trigger a specific function.

A speech synthesizer is used which automatically synthesizes the keywords, that is as audio playback, and feeds them to the speech recognizer in order to then insert its output into the database of the speech interpreter as further synonyms if they differ from the keywords or their synonyms. Consequently, recursive feeding of the systems takes place. The systems are computers with memories and processors on which known operating systems work.

In a further embodiment, the speech synthesizer is configured such that the keywords are synthesized cyclically with different speech parameters. The parameters comprising the following parameters: speaker's age, speaker's sex, speaker's accent, speaker's pitch, volume, speaker's speech impediment, emotional state of the speaker, other aspects are of course conceivable.

Different speech synthesizers can also be used, preferably one or a plurality of the following: a concatenative synthesizer, a parametric synthesizer. Depending on the synthesizer, it uses either different domains or different parameters, where a different domain should also stand for a different parameter.

The automatic cyclical synthesis of the keywords is dependent on events. Thus new keywords, modified synthesizer, expiry of a period of time may be used as events, as a result of which the database with the keywords is re-synthesized to obtain new terms.

To date, technical systems which match user utterances and database entries with each other, thus in principle all information systems with speech access, use various vocabulary data sources, sometimes also simply the Internet cf. [1], for matching the identifiers and finding synonyms.

In an embodiment, the invention includes feeding the speech recognizer automatically with the words to be recognized by means of a speech synthesizer and then making the results, because they then differ from the input, available to the interpreter as synonyms or utterance variations. This improves the matching between user utterance and database entry.

As this process is completely automated, it can be integrated inexpensively in an overall system.

For controlling an information system, which is accessible, for example, via a smartphone or a hifi system, commands or instructions input linguistically/vocally must be interpreted into computer instructions. In the case of an information system, there is at the same time a limited number of words which the user can utter, namely the identifiers for the information content in which he is interested. They must be matched with the identifiers of the information content in the database.

Problems may arise here at two points:
a) The user uses different identifiers to the database to identify the information content.
b) The automatic speech recognition misunderstands the user and as a result the identifiers cannot be matched.

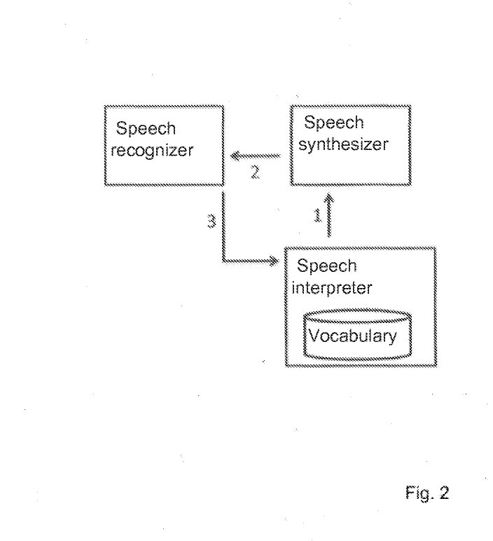

For both cases it is helpful to provide the database entry with alternative identifiers, so-called synonyms. Synonyms therefore constitute a very central component of such an information system. The invention described here generates synonyms completely automatically in that the entries of the database are generated by the speech synthesizer in different voices and are fed to a speech recognizer. At the same time, the speech recognizer feeds back alternative orthographic representations. These are used as synonyms and thus improve matching between user utterance and database entry. The process is illustrated in FIG. 2.

### Embodiment 1

### Cinema Information

A system for cinema information is described in the following as a specific embodiment of this invention. The system is notified every night at 3:00 of the current cinema programme for the next two weeks, including the actors' names. The system sends all the actors' names to the speech recognizer, in the case of “Herbert Gronemeyer” it receives “Herbert Gronemeier” as an answer. As the last name differs in this case, it is added to the vocabulary as a synonym. If afterwards a user says “films with Herbert Gronemeyer”, the interpretation can assign the correct actor although the recognizer has sent back a result with different orthography.

### Embodiment 2

### Autoscout24 Voice Search

A further embodiment concerns the voice search of the Autoscout 24 database for second-hand cars. The names of the models are regularly updated in the speech interface system of the database to keep the vocabularies current. During updating, the names of the models are generated by a speech synthesizer and fed to the speech recognizer, in the process the model name “Healey”, for example, is recognized as “Heli” and the entry “Heli” is then added as a synonym to the entry for the model “Healey”.

### Supplementary Materials

Some supplementary information, which is intended to clarify and illustrate the application scenario, is attached below.

The mode of operation of the inventive idea is illustrated schematically in FIG. 2. The keywords originally present are fed to the speech synthesizer (1) which synthesizes speech audio data from them. These data are transmitted to the speech recognizer (2) which passes a recognized text to the speech interpreter (3). If the keywords received back differ from the text data originally transmitted, then they are added to the vocabulary as synonyms.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A device for automated improvement of digital speech interpretation on a computer system, the device comprising:
a speech recognizer, configured to recognize digitally input speech;
a speech interpreter, configured to accept the output of the speech recognizer as an input, and to manage a digital vocabulary with keywords and their synonyms in a database in order to trigger a specific function; and
a speech synthesizer, configured to automatically synthesize the keywords and to feed them to the speech recognizer in order to then insert its output as further synonyms into the database of the speech interpreter if they differ from the keywords or their synonyms.

2. The device according to claim 1, wherein the speech synthesizer is further configured to feed the synthesized synonyms to the speech recognizer in order to enter new synonyms in the database in case of deviations.

3. The device according to claim 1, wherein the speech synthesizer is further configured to synthesize the keywords cyclically using different speech parameters, comprising one or more of the following parameters: speaker's age, speaker's sex, speaker's accent, speaker's pitch, volume, speaker's speech impediment, emotional state of the speaker.

4. The device according to claim 1, wherein the speech synthesizer comprises one or more of the following: a concatenative synthesizer, a parametric synthesizer.

5. The device according to claim 3, wherein the automatic cyclical synthesis of the keywords is dependent on one or more of the following events: modified keywords, modified synthesizers, expiry of a period of time.

6. A method for automated improvement of digital speech interpretation on a computer system having a speech recognizer which recognizes digitally input speech, a speech interpreter which accepts the output of the speech recognizer as an input and manages a digital vocabulary with keywords and their synonyms in a database in order to trigger a specific function, and a speech synthesizer which automatically converts synthesized keywords into spoken text, the method comprising:
accessing, by the speech synthesizer, the keywords in the database and automatically converting the keywords into spoken language so as to have them recognized by the speech recognizer in order to insert them as further synonyms into the database of the speech interpreter if they differ from the keywords or their synonyms.

7. The method according to claim 6, wherein the speech synthesizer is further configured to feed the speech recognizer with the synthesized synonyms in order to enter new synonyms in the database in the case of deviations.

8. The method according to claim 6, wherein the speech synthesizer is further configured to synthesize the keywords cyclically using different speech parameters, comprising the following parameters: speaker's age, speaker's sex, speaker's accent, speaker's pitch, volume, speaker's speech impediment, emotional state of the speaker.

9. The method according to claim 6, wherein the speech synthesizer comprises one or more of the following: a concatenative synthesizer, a parametric synthesizer.

10. The method according to claim 8, wherein the automatic cyclical synthesis of the keywords is dependent on one or more of the following events: modified keywords, modified synthesizers, expiry of a period of time.
